(19) United States
(12) Patent Application Publication
(10) Pub. No.: US 2016/0210585 A1
(43) Pub. Date: Jul. 21, 2016

(54) METHOD AND APPARATUS FOR A PORTABLE DISPLAY DEVICE

(71) Applicant: Exposure Illumination Architects, Inc., Scottsdale, AZ (US)

(72) Inventor: Daniel S. Spiro, Paradise Valley, AZ (US)

(21) Appl. No.: 14/997,240

(22) Filed: Jan. 15, 2016

Related U.S. Application Data
(60) Provisional application No. 62/103,969, filed on Jan. 15, 2015.

(51) Int. Cl. G06Q 10/08; G06F 3/14

(52) U.S. Cl. CPC G06Q 10/087; G06F 3/14

(57) ABSTRACT

The present technology may relate to a product information system for guiding a navigation device to a product located in a defined space. Various embodiments of the product information system may comprise a centralized server configured to contain a database of product information and a display device for displaying the product information. The display device may comprise a housing, a display panel coupled to the housing and visible from an outside surface of the housing, a communication module disposed within the housing and communicatively linked to the centralized server, and a control unit. The communication module may be configured to receive product information from the centralized server and transmit a location of the display device to the centralized server and/or the navigation device in real time. The control unit may be configured to detect the location of the display device within the defined space, process the received product information, and operate the display panel to display the processed product information.

### CROSS-REFERENCES TO RELATED APPLICATIONS

This application claims the benefit of U.S. Provisional Patent Application No. 62/103,969, filed Jan. 15, 2015, and incorporates the disclosure by reference. To the extent that the present disclosure conflicts with any referenced application, however, the present disclosure is to be given priority.

### BACKGROUND OF INVENTION

Retailers display their products' cost, cost per unit, nutrition, discounts, and other pertinent information about their products on display tags or panels. In a shelf merchandising environment, such as a supermarket or a racked retail warehouse, the location of the display tags and pricing changes regularly. To avoid revenue loss and/or loss of customer satisfaction, proprietors must follow a rigorous regime to maintain accurate pricing and tag locations. This regime requires the generation of accurate tags and then having them physically placed at correct locations. Environments where there is high merchandise turnover, a large number of items, and where products' location frequently changes in the store are at higher risk for mistakes.

Electronic tags may be used an alternative to traditional tags. The electronic display requires a power supply such as a battery or wired connectivity. To update information, the electronic tag may need a hand held device. Current electronic display panel technology has several disadvantages, including initial high cost, higher operational cost, and may require time and resource consuming methods to validate proper tag placement.

### SUMMARY OF THE INVENTION

The present technology may relate to an addressable product information system for guiding a navigation device to a product located in a defined space. Various embodiments of the product information system may comprise a centralized server configured to contain a database of product information and a display device for displaying the product information. The display device may comprise a housing, a display panel coupled to the housing and visible from an outside surface of the housing, a communication module disposed within the housing and communicatively linked to the centralized server, and a control unit. The communication module may be configured to receive product information from the centralized server and transmit a location of the display device to the centralized server and/or a navigation device in real time. The control unit may be configured to detect the location of the display device within the defined space, process the received product information, and operate the display panel to display the processed product information.

### BRIEF DESCRIPTION OF THE DRAWINGS

A more complete understanding of the present invention may be derived by referring to the detailed description when considered in connection with the following illustrative figures. In the following figures, like reference numbers refer to similar elements and steps throughout the figures.

FIG. 1A-C representatively illustrate a front view, alternate front view, and side view, respectively, of an exemplary display device;

FIG. 1D representatively illustrates a side view of the exemplary display device comprising a power storage medium;

FIG. 1E representatively illustrates a block diagram of the internal electrical components of the exemplary display device;

FIG. 2A representatively illustrates an exemplary product information system implemented in a retail structure;

FIG. 2B representatively illustrates a side view of the exemplary product information system implemented in a retail structure;

FIG. 2C representatively illustrates a block diagram of an exemplary product information system according to an embodiment of the present technology;

FIG. 3A representatively illustrates a front view of the exemplary display device powered by a dedicated photovoltaic converter;

FIG. 3B representatively illustrates a front view of the exemplary display device powered by integrated photovoltaic cells;

FIG. 3C representatively illustrates a front view of the exemplary display device powered by a photovoltaic power strip; and

FIG. 4 representatively illustrates a flowchart of activating and validating the portable display device.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various process steps, apparatus, systems, methods, etc. In addition, the present technology may be practiced in conjunction with any number of systems and methods for providing product information systems, and the system described is merely one exemplary application for the technology. Further, the present technology may employ any number of conventional techniques for installing, controlling, enhancing, retrofitting, monitoring, updating, and/or replacing product information tags.

The particular implementations shown and described are illustrative of the technology and its best mode and are not intended to otherwise limit the scope of the present technology in any way. For the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

Various representative implementations of the present technology may be applied to any shelving units, lighting units, mobile carts, product display systems such as racks or refrigeration units, and/or ceiling or wall mounted systems, within a structure. Certain representative implementations may include, for example, systems or methods for providing product information in any retail structure such as a grocery store and/or clothing retail store. In some embodiments, the product information system may be implemented with any item such as books in a bookstore and/or art pieces in a museum. For example, the product information system may display product information such as history of the artwork, its artist, author, pricing, stock, availability, and the like.

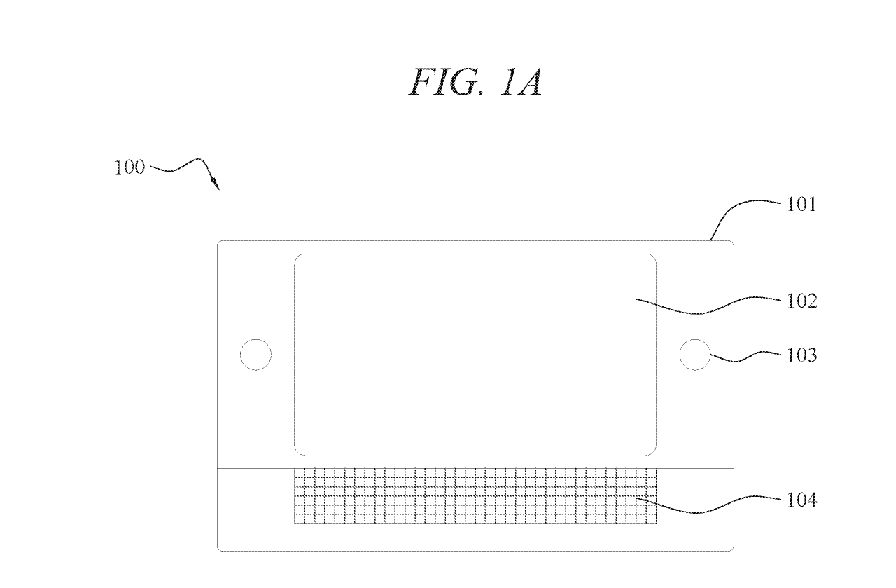

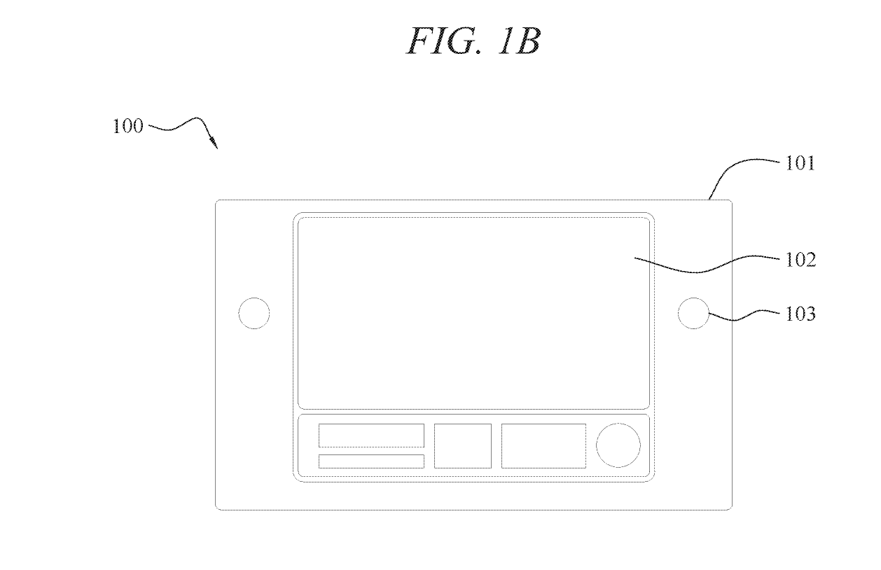

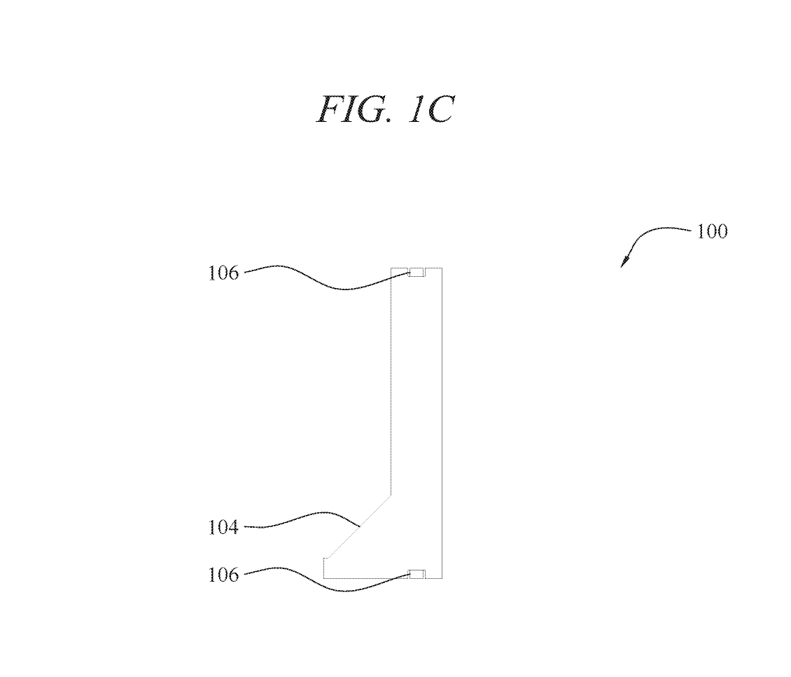

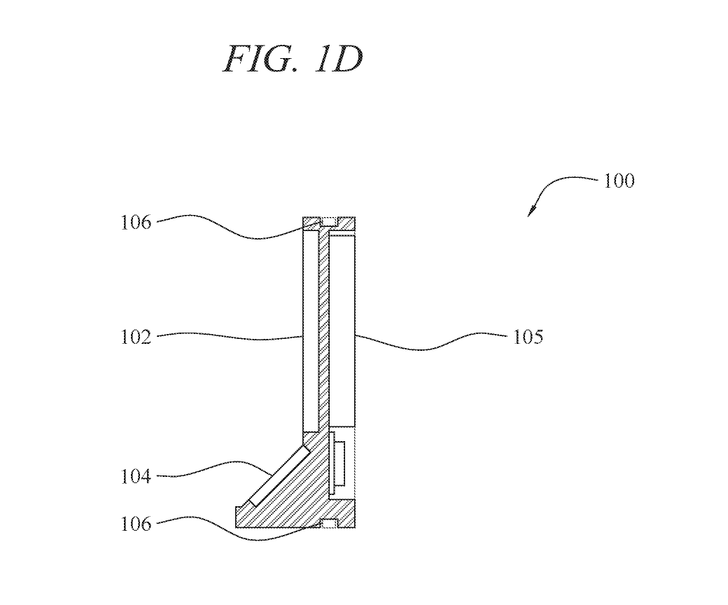

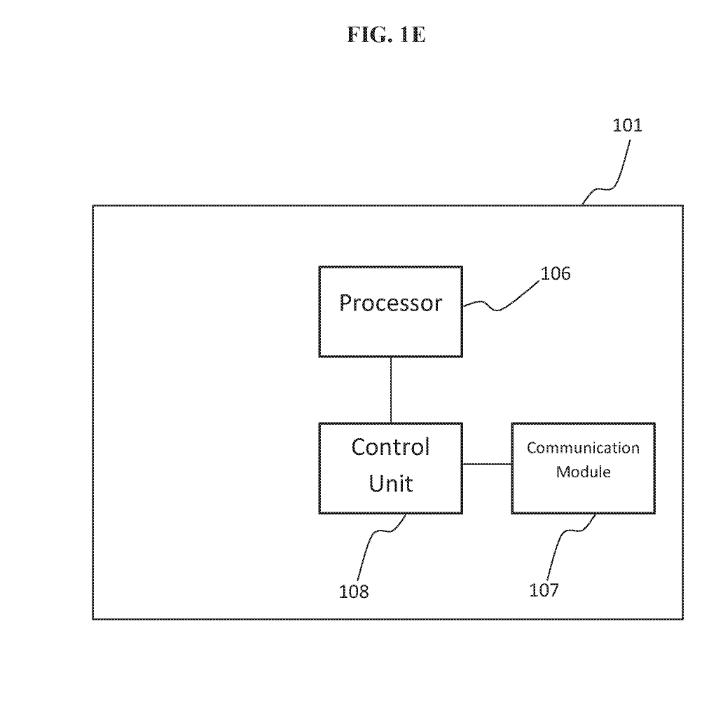

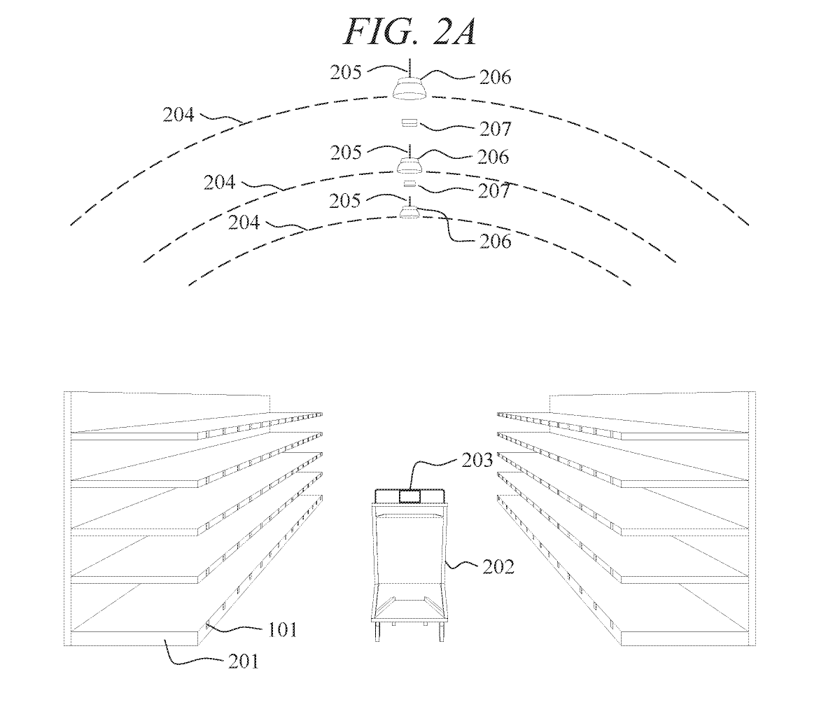

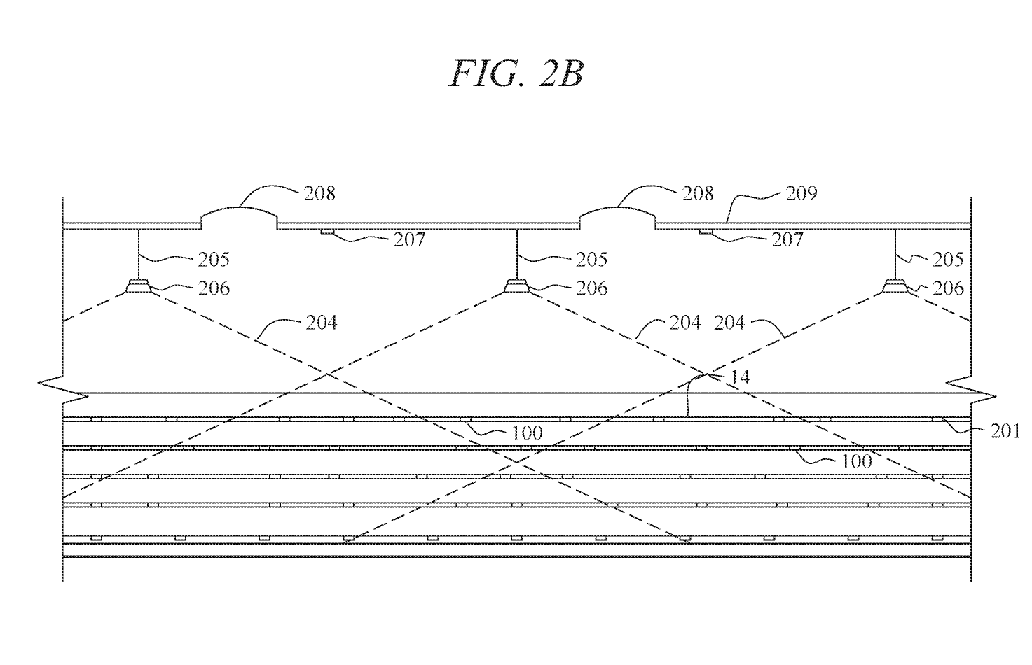

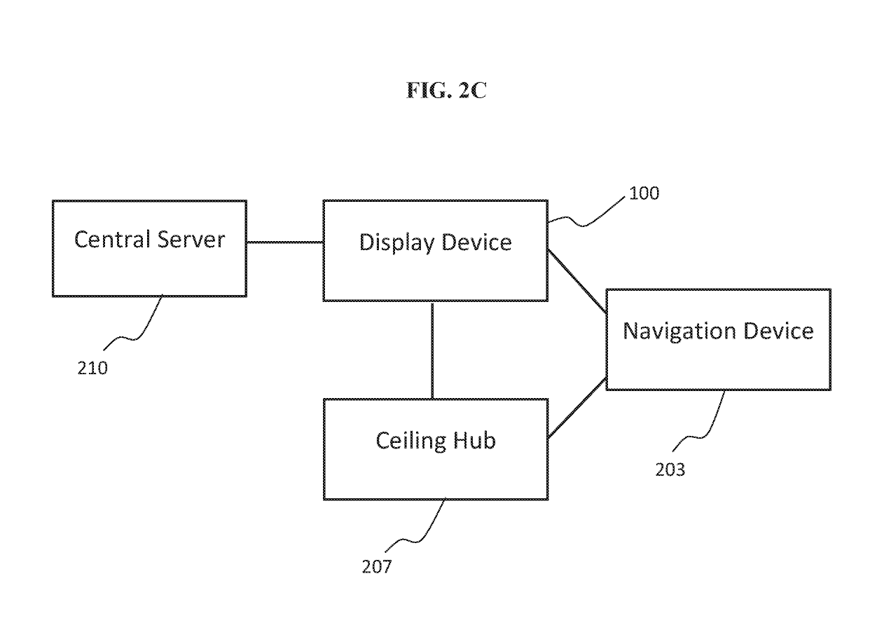

Referring now to FIGS. 1A-1D and 2A-2C, in one embodiment of the present technology, the product information system may comprise a portable display device 100. The display device 100 may be configured to display information regarding a product. The display device 100 may be further configured to transmit and/or receive information to and/or from a navigation device. The navigation device may be configured to visually and/or audibly direct a user to the display device 100. The display device 100 may be configured to validate that the information to be displayed is correct. The display device 100 may be further configured to receive updated information from a centralized server, direct input, and/or another electronic device.

In one embodiment, the display device 100 may comprise a housing 101. The housing may comprise any suitable device or system configured to house the electrical components of the display device 100 as well as being configured to be coupled to another structure, such as a shelf 201. The housing may also be configured to house a plurality of components, including, but not limited to, a display panel 102, a plurality of photovoltaic cells 104, a storage medium 105, a processor 106, a communication module 107, a control unit 108, and a location broadcaster 109.

Now referring to FIG. 1E, in one embodiment, the display device 100 may comprise a processor 106, a communication module 107, a control unit 108, and a location broadcaster 109. The communication module 107 may be configured to receive information from an external source. The received information may be passed to the processor 106 for processing. The processor 106 may be configured to alert the control unit 108 to perform a task. For example, the communication module 107 may receive from a centralized server 210 a list of the latest pricing information regarding a product. The communication module 107 may pass this information to the processor 106. The processor 106 may determine that the current pricing information associated with the display device 100 does not match the latest pricing information received by the communication module 107. In that case, the processor 106 may be configured to direct the control unit 108 to perform a pricing update on the display device 100. The communication module 107 may be configured to broadcast and/or otherwise disclose a geographical location of the display device 100 within a geographically define space.

In one embodiment, the communication module 107 may comprise any suitable system or device configured to transmit and/or receive information to and from the display device 100. The communication module 107 may be communicatively coupled to the processor 106, the control unit 108, and/or the centralized server 210.

The communication module 107 may be configured to receive information from a centralized server 210, an electronic device, and/or manual inputs. The communication module 107 may be configured to transmit information to the centralized server 210, an electronic device, and/or a navigation device. The communication module 107 may be configured to transmit and receive information over a variety of communication channels, including but not limited to, wired connections, wireless connections such radio frequency, cellular, Bluetooth™, WIFI, and/or the like. The communication module 107 may be configured to receive product information from the centralized server 210 and transmit a location of the display device 100 within the defined space to at least one of the central server 210 and the navigation device in real time.

In one embodiment, the communication module 107 may be configured to operate in conjunction with a price scanner. The price scanner may comprise any suitable system or device configured to send and receive information to and from a the price scanner to a product. For example, the price scanner may be utilized to scan (e.g., read) the display device 100 to obtain the pricing information of the product associated with that particular display device 100. The display device maybe configured to retrieve pricing information from the centralized server 210 before providing that information to the price scanner. In another example, the price scanner may be utilized to update the information to be displayed by the display device 100. For example, an employee may want to change the price associated with a single display device 100. The communication module 107 of the display device 100 may be configured to receive the price update information from the price scanner and adjust the price to be displayed by the display panel 102.

In one embodiment, the communication module 107 may be activated manually or automatically. For example, the communication module 107 may be configured to perform a set of tasks automatically at a given time of the day. The communication module 107 may also be configured to be manually activated. For example, the pricing information may be updated manually, and the communication module 107 may be activated to perform a pricing validation against a reference pricing sheet.

In various embodiments, the communication module 107 may be configured to receive electrical power directly from the same source as the display device 100, and/or the communication module 107 may be configured to receive electrical power from the power storage medium 105. The communication module 107 may be configured to be in a resting, off, or power-saving mode when not being used in order to converse electrical power usage.

In one embodiment, the control unit 108 may be configured to oversee the operation of the display device 100 (and its components), as well as the processor 106 and the communication module 107. The control unit 108 may be communicatively linked to at least one of the processor 106, the communication module 107, centralized server 210, and/or the navigational device 203. The control unit 108 may comprise any suitable system or device configured to receive and process information to cause an action to be taken. For example, the control unit 108 may be configured to activate or deactivate the display device 100 based on factors such as time of day, received light levels, usage conditions, and/or other related factors.

The control unit 108 may be configured to activate or deactivate the display device 100 based on a variety of factors. For example, the control unit 108 may be configured to activate the display device 100 when the received light level reaches a predetermined threshold. The control unit 108 may be configured to deactivate the display device 100 when the received light level is below a predetermined threshold.

The control unit 108 may be configured to display product information to the display panel 102. The product information may comprise any information related to a product, such as pricing information, product quantity, promotional offers, coupons/discounts, product quality, history, availability, nutritional content, materials, and/or the like. In some embodiments, the control unit 108 may be configured to verify the display information against a reference database. For example, if the display device 100 is configured to display pricing information for a product in a grocery store, the control unit 108 may be configured to operate the communication module 107 to obtain a current pricing information for the product, verify that the current pricing information for the product matches what is about to be displayed by the display panel 102, and perform any updates necessary so that the pricing information matches.

The control unit 108 may be configured to receive electrical power directly from the same source as the display device 100, or the control unit 108 may be configured to receive electrical power from the power storage medium 105. The control unit 108 may be configured to be in a resting, off, or power-saving mode when not being used in order to converse electrical power usage.

In one embodiment, the control unit 108 in conjunction with the communication module 107 and processor 106 may be configured alert a centralized server of the location of the display device 100 upon a change to the location of the display device 100. For example, if the display device 100 is moved from a first location to a second location within the defined space, the display device 100 may be configured to alert the centralized server via the communication module 107 that the location of the display device 100 has been modified. After the display device 100 has been moved to the new location, the display device 100 may be configured to broadcast and/or otherwise alert to the centralized server the new location information. In one embodiment, the control unit 108 may be configured to detect the location of the display device 100 within the defined space, process received information regarding a product, and operate the display panel 102 to display the product information.

In various embodiments, the control unit 108 may comprise the processor 106 and/or the processor 106 may be communicatively linked to the control unit 108. In one embodiment, the processor 106 may be configured to analyze and process information received from at least one of the communication module 107 and the control unit 108. The processor 106 may comprise any suitable processor configured for low-power operation. The processor 106 may be communicatively linked to the communication module 107, the control unit 108, the centralized server 210, and/or the navigational device 203.

In some embodiments, the display device 100 may be configured to report its location within the defined space either on an X-Y (two dimensional) scale or an X-Y-Z (three dimensional) scale. For example, a display device 100 may be associated with a product within a store at a particular location. For example, the display device 100 may report its location based on an X and Y-coordinate system, whereby a two dimensional map is generated showing an overhead layout of the location of each display device 100 currently broadcasting its location. The display device 100 also be configured to report its location based on the X, Y, and Z-coordinate system, whereby a three dimensional map is generated showing not only where a product is in relation to its X and Y coordinates, but also a height. For example, multiple products (and their display devices) may be stacked on top of each other such that locating a specific product may require the additional Z-coordinate. The display device 100 may broadcast and/or otherwise transmit its location to another system or device such as a navigation device 203.

In addition to broadcasting and/or reporting its location, each display device 100 may be individually addressable and referenceable. In other words, a particular display device 100 within a network of multiple display devices 100 may be singled out to perform a task or provide additional information. The data/information to be displayed by a particular display device 100 may be verified and/or otherwise validated to ensure that the correct information and/or data is being displayed. For example, the display device 100 may act as a price tag, displaying the price of the product currently associated with the display device 100. In some embodiments, a particular display device 100 may be audited to ensure that the data/information to be displayed (e.g., price information) is accurate.

In one embodiment, each display device 100 within the network of display devices 100 may be assigned an address (e.g., an IP address) that may configured to identify a unique (individual) display device 100 within the network. The display device 100 may be assigned an address using any suitable system or device configured to assign a unique identifier to an item. For example, the centralized server may be configured to assign each display device 100 within the network of display devices 100 a unique address. In another example, a handheld device may be configured to assign a unique address to an individual display device 100.

Now referring back to FIGS. 1A, 1B, and 1D, in one embodiment, the display device 100 may comprise a display panel 102. The display panel 102 may comprise any suitable system or device configured to display visual information. The display panel 102 may be configured to display information in color, grayscale, and/or a combination of the two. The display panel 102 may comprise an LCD display panel and the like. The display panel 102 may require electrical power. The display panel 102 may receive electrical power from the power storage medium 105. The display panel 102 may be configured to receive information regarding what to display from the control unit 108.

In one embodiment, the display panel 102 may be configured to display information/data in a variety of formats, including but not limited to, alphanumeric, graphical, light modulation, and the like. For example, the display device 100 may be configured to display pricing information for a product associated with the display device 100. The brightness of the display may be configured to be variable depending on whether the display device 100 senses that something is near its location.

The display panel 102 may be further configured to display any information relating to a product or location depending on the context in which the display device 100 is utilized. For example, in the context of a retail store, the display panel 102 may be configured to display at least one of the identity of the product and the price of the product. In another application, the display panel 102 may be configured to display data/information relating to any attribute associated with an item/location such as quality, quantity, color, historical information, specifications, and/or the like. In some embodiments, the display panel 102 may be configured to rotate what is displayed. For example, the display panel 102 may be configured to rotate through displaying the price, quantity, and specifications of the product on a predetermined timing interval.

Now referring to FIGS. 1A, 1C-D, 2A, and 3A-C, in one embodiment, the display device 100 may comprise a plurality of photovoltaic cells 104 disposed on the housing 101. The photovoltaic cells 104 may be configured to convert daylight and/or artificial light into electrical power. The electrical power converted by the photovoltaic cells 104 may be stored in the power storage medium 105 and used at a later time. For example, the display device 100 may be directly coupled to an electrical power source during a portion of the day, and when the electrical power source is turned off during another portion of the day, electrical power to the display device 100 (and its various components) may be provided via the power storage medium 105.

Now referring to FIGS. 2A and 2B, in one embodiment, the received light may be generated in a fixed point in space 205 via a light emitting device 206. The light emitting device 206 may have a limited coverage range 204. The light emitting device 206 may be configured to emit any type of light.

The photovoltaic cells 104 may be coupled to the outside of the housing 101 such that the photovoltaic cells 104 receive maximum exposure to the light device 206. Depending on the application and orientation of the display device 100, the photovoltaic cells 104 may be disposed on an upper, lower, side, top, or bottom surface of the housing 101.

In an alternative embodiment, the photovoltaic cells 104 may be placed at a separate location from the display device 100. The photovoltaic cells 104 may be communicatively coupled to the display device 100 such that electrical power generated by the photovoltaic cells 104 at the separate location may be stored and used at a later time. For example, some portions of the geographical area may consistently have low light levels. In that case, the photovoltaic cells 104 may be configured with a greater number of photovoltaic cells to capture an adequate amount of light to power the display device 100. These photovoltaic cells 104 may each be communicatively coupled to individual display devices 100.

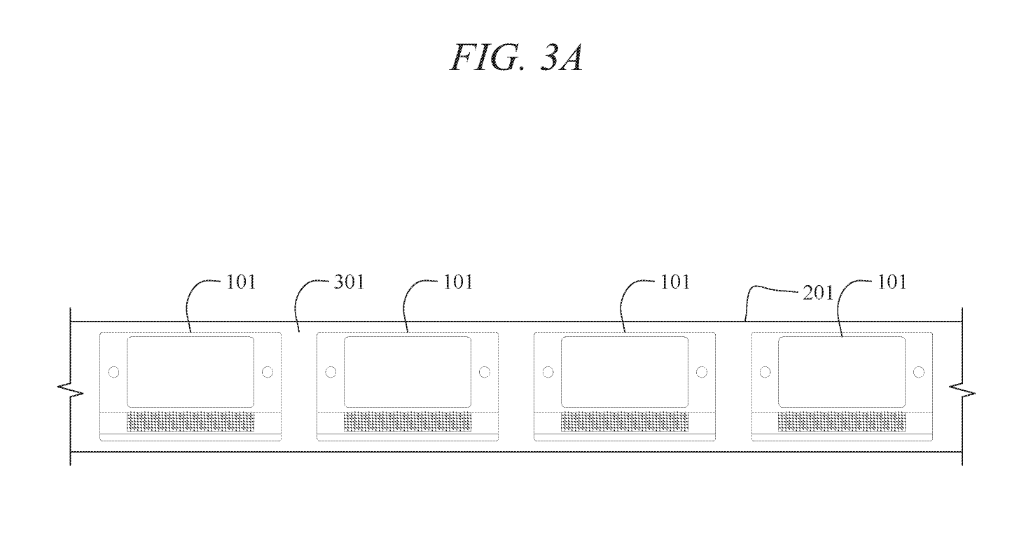

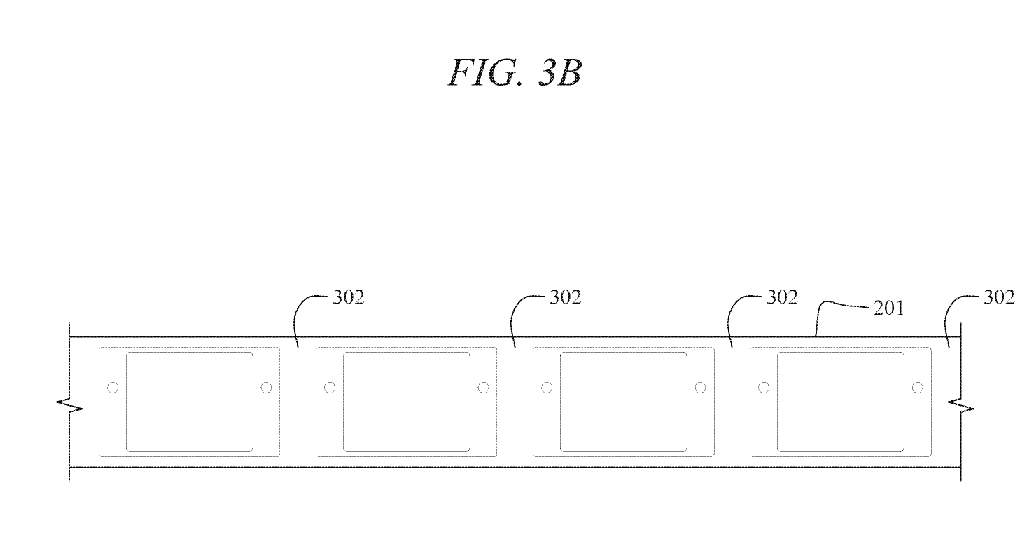

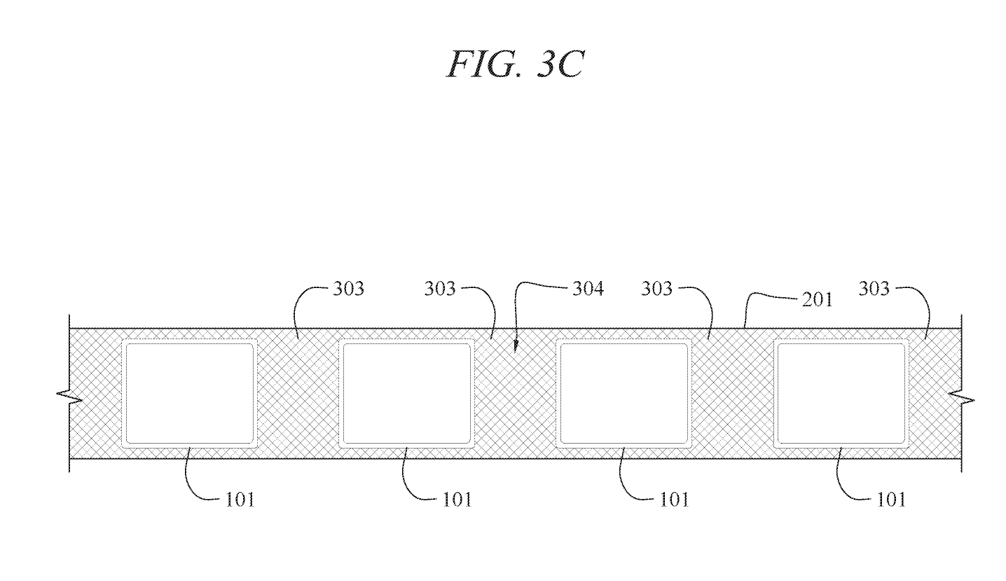

Now referring to FIG. 3A, in another embodiment, a display device 100 may be configured to be coupled to and receive power from a dedicated photovoltaic power board 301. The photovoltaic power board 301 may be configured with any suitable system or device configured to provide electrical power to the display device 100. The photovoltaic power board 301 may be configured to operate in conjunction with the photovoltaic cells 104 of the display device 100 to provide electrical power to the display device 100. The photovoltaic power board 301 may be configured to receive natural light and artificial light.

Now referring to FIG. 3B, in another embodiment, a display device 100 may be configured to be integrated into and receive power from a photovoltaic cell strip 302. In one embodiment, the integrated photovoltaic cell strip 302 may take the place of the photovoltaic cells 104 to supply power to the display device 100. The photovoltaic cell strip 302 may be configured to provide electrical power to the display device 100 by converting received light to electricity as discussed above.

Now referring to FIG. 3C, in another embodiment, a display device 100 may be powered by a photovoltaic strip 303. The photovoltaic strip 303 may be configured to provide electrical power to the display device 100 by converting received light to electricity as discussed above.

Now referring to FIG. 1D, in one embodiment, the display device 100 may comprise a power storage medium 105. The power storage medium 105 may comprise any suitable system or device configured to store electrical power for the display device 100. The power storage medium 105 may be disposed within the housing 100 and may be electrically coupled to at least one of the display devices 100 components such as the display panel 102, photovoltaic cell 104, processor 106, communication module 107, and/or control unit 108.

The power storage medium 105 may comprise a capacitor (not shown). If the display device 100 does not use the entirety of the electrical power generated by the photovoltaic cells 104, the excess electrical power may be stored in the capacitor for use at a later time. The power storage medium 105 may be configured to provide backup and/or emergency power in the event that no light is available, and in the event that provided electrical power from an external source is insufficient.

In various embodiments, the power storage medium 105 may be electrically coupled to the processor 106, the communication module 107, and/or the control unit 108. The power storage medium 105 may be utilized automatically and/or manually. The power storage medium 105 may be configured to provide power based on factors such as time of day and/or meeting power requirements. For example, the display device 100 may be configured to operate on direct power from the photovoltaic cells 104 when the display device 100 is actively receiving light. The display device 100 may be configured to operate on power supplied by the power storage medium 105 when the display device 100 is not actively receiving light and/or receiving low light (for example, when a store is turned off during non-business hours). In the event of an emergency or loss of power, the display device 100 may be configured to automatically switch to obtaining electrical power from the power storage medium 105.

Now referring to FIGS. 1C and 1D, in one embodiment, the housing 100 may be configured with an attachment system 106. The attachment system 106 may comprise any suitable system or device configured to couple the display device 100 to a structure. For example, in the context of a grocery store, the attachment system 106 of the display device 100 may be configured to be coupled to a shelf 201 below a product. The attachment system 106 may be disposed on any portion of the housing, including the front, back, sides, lower, and upper sections of the housing. The attachment system 106 may comprise adhesives, clips, hooks, fasteners, and/or the like.

In one embodiment, the display device 100 may be configured with speakers (not shown). The speaker may comprise any suitable system or device configured to produce an audible notification. The speaker may be disposed on the housing 101 of the display device 100 or the speaker may be disposed at a remote location away from the display device 100 and communicatively coupled to the communication module 107. In the case of remote speakers, the speaker may be configured with any suitable system or device configured to receive data/information from one or more display devices 100. A speaker may be configured to be associated with a certain subset of display devices 100 within a network of display devices 100. For example, it may be the case that a defined space may only comprises 20 speakers distributed amongst the area. In that case, each speaker may be associated with a group of display devices 100 within the geographically defined region near that particular speaker.

The speaker(s) may be configured to project pre-recorded audible messages and/or customized audible messages. The speaker(s) may be further configured to project audible messages upon the occurrence of a condition and/or event. For example, if the display device 100 senses that one of its components have failed, it may project an audible alert such that the display device 100 may be serviced. The speaker(s) may be configured to receive data/information to and from display devices 100, a centralized server, an electronic device, and/or the like. The data/information may be transmitted using any suitable method or medium such as wireless, wired, Bluetooth™, cellular, WIFI, radio frequency, and/or the like.

In one embodiment, the display device 100 may comprise an alert module communicatively coupled to at least one of the processor 106, the communication module 107, and the control unit 108. The alert module may comprise a beacon or a speaker as discussed above. The beacon or speaker may be configured to be automatically activated when the navigation device is within a certain predetermined threshold distance of a geographical location.

In one embodiment, the display device 100 may comprise an infrared occupancy sensor configured to dim the brightness of the display panel 102 in the absence of occupancy and prompt full brightness of the display panel 102 during occupancy. For example, the display device 100 via the occupancy sensor may determine that a user is in front of (or in proximity to) the infrared occupancy sensor. The display panel 102 may increase its brightness level when it has detected that a user is in proximity to the display device 100.

Now referring to FIG. 2A, in one embodiment, the display device 100 may be configured to operate in connection with a navigation device 203. The navigation device 203 may comprise any suitable system or device configured to provide navigational prompts to a user. For example, the navigation device 203 may comprise an electronic device with its own display panel, wherein the display panel is configured to display to the user navigational directions to a particular display device 100. In one embodiment, the navigation device 203 may be configured to be disposed to another object such as a shopping cart or as a software application on an electronic device such as a cell phone. The navigational prompts/directions provided to the user may comprise visual and/or audio prompts. For example, audible directions such as “turn left,” “turn right,” “50 feet ahead,” and the like may be provided. Similarly, arrows or other indicators may be shown on the display panel of the navigation device 203 so that the user may follow the arrows/indicators to their desired location. The navigation device 203 may be configured with a floorplan layout of a space to be navigated. The floorplan may incorporate the location of a plurality of display device 100 devices, wherein each display device 100 device is associated with a particular item for sale.

In one embodiment, the communication module 107 may be configured to transmit and receive information to and from the navigation device 203. The transmission and/or receiving of information between the display device 100 and the navigation device 203 may be facilitated using any suitable method such as wired, wireless, WIFI, Bluetooth™, cellular, radio frequency, and/or the like. After the information is received by the navigation device 203 from the display device 100, the navigation device 203 may guide and/or otherwise assist in navigating a user to a particular display device 100. For example, if the user in a grocery store is looking to purchase a certain product, the navigation device 203 may be configured to assist the user in navigating the grocery store aisles until they reach the particular product the user is looking for.

In one embodiment, the navigation device 203 may be preconfigured with a multidimensional map or floorplan of the defined geographical space. For example, in the context of a grocery store, the navigation device 203 may be configured with the map of the grocery store, including the location of aisles and a plurality of display devices 100. In some embodiments, the multidimensional map may be maintained by the centralized server 210 and communicates to the navigational device 203.

In some embodiments, the navigation device 203 may be configured to dynamically generate a floorplan layout of a space based on the sensed locations of a plurality of display devices 100. For example, it may be the case that the defined space does not have a predetermined layout, or the location may have a floorplan that is dynamic and always changing. In that context, the navigation device 203 may be configured to automatically generate the multidimensional map based on the sensed locations of a plurality of display devices 100 within the defined space. For example, a swap meet may comprise numerous stalls/shops spread out over an area. Each individual stall/shop may utilize a plurality of display devices 100 to display pricing for their goods. Each display device 100 may broadcast and/or otherwise communicate its location to the navigation device 203, and the navigation device 203 may compile the locations of each display device 100 to form the multidimensional map of the each stall/shop and the products currently being offered for sale.

In yet another embodiment, the display device 100 may transmit data/information in real time. A second device (e.g., another display device 100, a navigation device 203, and/or the centralized server 210) may detect the display device's 100 actual location in relation to a reference plan that contains the correct locations of each specific display device 100. The location data can be displayed on the display device's 100 display panel 102. The display panel 102 may be configured to display X, Y, and Z coordinates, forward/backward, right/left, and/or high/low prompts. The display device 100 may also be assigned a location by a hand held device such as a cell phone, tablet, and/or dedicated device. Once assigned, the X, Y and Z locations of the particular display device 100 may be recorded in the reference plan. After verifying/validating its location, the display device 100 may request from the centralized sever 210 the storage time of the last update. If any update(s) occurred after the display device's 100 last update the display device 100 may be configured to download the current update(s). This process may repeat periodically and can be programmed into the display device 100 as needed remotely and/or directly into the display device 100.

Referring again back to FIG. 2A, in one embodiment, a ceiling hub 207 may be utilized to assist in the transmission and/or receiving of information between display devices 100, centralized servers 210, electronic devices, and/or navigation devices 203. The ceiling hub 207 may be communicatively linked to the control unit 108 and/or the navigation device 203 such that data/information may be relayed between the control unit 108 of a particular display device 100 and the navigation device 203. The ceiling hub 207 may be configured to be attached to a surface in a fixed position and within communication range of the navigation device 203. The ceiling hub 207 may comprise any suitable system or device configured to receive an incoming dataset and/or information and relaying that dataset/information to another device or location. For example, it may be the case that the broadcast range of the display device 100 cannot permeate the entirety of a space. In that case, the ceiling hub 207 may be configured to relay the dataset/information from a first display device 100 to a second device such as a second display device 100.

In various embodiments, the ceiling hub 207 may be configured to receive and/or transmit signals using a variety of methods, including but not limited to, wireless, wired, Bluetooth™, cellular, WIFI, radio frequency, and/or the like. The ceiling hub 207 may comprise additional components configured to process data/information before transmission. For example, the ceiling hub 207 may be configured to relay the location of a particular display device 100 to a navigation device 203 at a location beyond the native broadcasting range of the display device 100. In that case, the ceiling hub 207 may receive location data/information from the display device 100, process the data/information to determine which navigation device 203 to transmit the location data/information to, and then transmit the location data/information to that display device 100.

In some embodiments, the ceiling hub 207 may be configured to assist in the verification/validation process in activating the display device 100. For example, the ceiling hub 207 may be utilized such that one display device 100 may transmit its location data/information to a centralized server to verify whether the display device 100 is in the correct location, wherein the ceiling hub 207 acts as a data/information relay between the display device 100 and the centralized server 210.

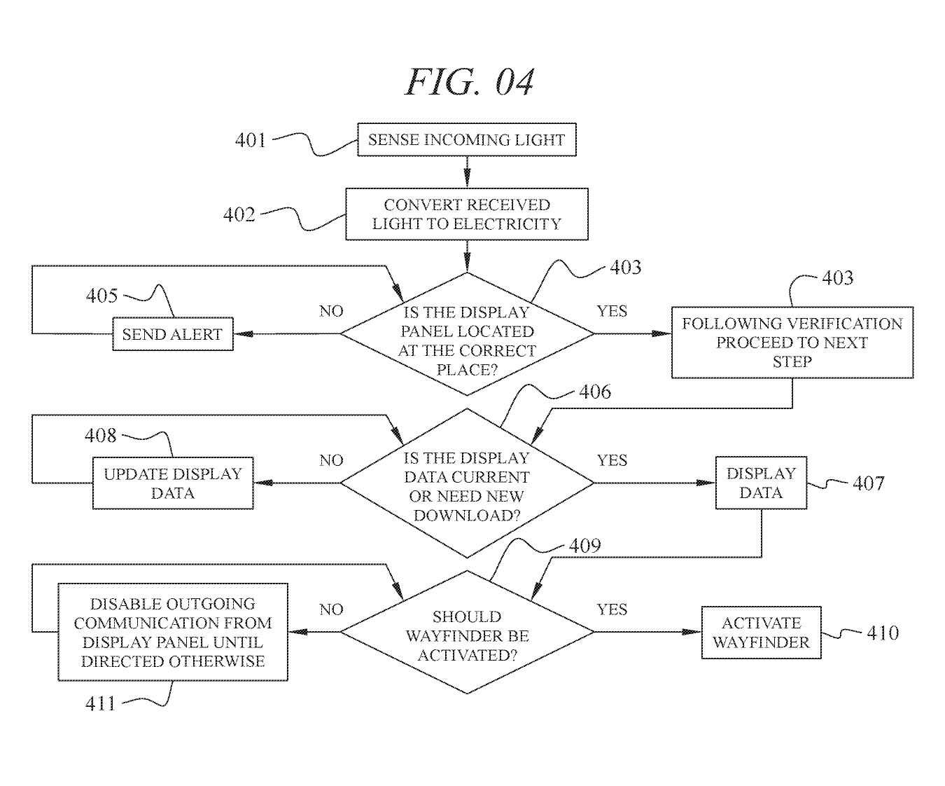

Now referring to FIG. 4, in operation, the product information system may activate the display device 100 based on the sensed/detected incoming light level (401). Once activated, the photovoltaic cells 104 of the display device 100 may be configured to convert light into electrical power as discussed above (402). The display device 100 may perform a verification process to ensure it is located at the correct location (403). The display device 100 may also verify whether the data/information to be displayed by the display panel 102 is accurate (406). The display device 100 may also determine whether the navigation device 203 needs to take an action or not (409).

In one embodiment, the display device 100 may be activated upon the detection of a predetermined threshold light level (401). The predetermined threshold light level required to activate the display device 100 may be customized depending on the usage of the display device 100.

In one embodiment, as discussed above, the photovoltaic cells 104 of the display device 100 may be configured to convert light into electrical power (402). The received light may comprise any light source including natural and/or artificial light. For example, the photovoltaic cells 104 may be configured to convert natural sunlight and/or artificial light such as the light generated from light bulbs.

In one embodiment, once the display device 100 has detected an adequate light level and has been activated, the display device 100 may undergo a verification/validation process to check whether the display device 100 is located in the correct location. The verification/validation process may comprise any method configured to verify one set of data against another set of data. For example, to verify whether a particular display device 100 is in the correct location, the display device 100 may be configured to broadcast and/or otherwise disclose its location to another system or device (e.g., a centralized server). The receiving system or device may be configured with a reference data that is configured with an up to date listing of where each display device 100 is supposed to be located.

If the verification/validation process determines that the display device 100 is located in the correct location (403), the display device 100 may be configured to determine whether its product information to be displayed is accurate and/or up to date (406). If the verification/validation process determines that the display device 100 is located in the incorrect location, the display device 100 may alert another system, device, and/or entity of the error. The display device 100 may transmit an alert using any suitable system or device configured to transmit information from one source to another. For example, the display device 100 may be configured to utilize the communication module 107 to report to the centralized server 210 that the display device 100 is in the incorrect location.

In one embodiment, the alert may comprise any suitable system configured to alert that the display device 100 is located at an incorrect location. The alert may comprise visual information such as flashing lights and/or the alert may comprise audible information such as beeps and the like. The alert may also be transmitted to the centralized server 210 and/or another electronic device.

In another embodiment, the alert may be triggered upon the occurrence of an event and/or condition. The event and/or condition may be predetermined or occur spontaneously. For example, alerts may be configured to be activated upon the display device 100 detecting that it is running out of electrical power, failure of one or more components (e.g., display panel, power storage medium, photovoltaic cells 104). In another example, the alerts may be configured to be activated when the navigation device 203 requests information (e.g., location information) from the display device 100.

In one embodiment, after the display device 100 has determined that it (the display device 100) is in the correct location, the display device 100 may perform a verification/validation process to determine whether the data/information to be displayed by the display panel 102 is accurate, or if the data/information to be displayed requires updating (406). The display device 100 may be configured with any suitable system or device configured to verify/validate one set of data against another. For example, the display device 100 may communicate to the centralized server 210 and/or the navigation device 203 that it is located at a certain X and Y (or X, Y, and Z) coordinate within the defined space. The location data may be transmitted, via the communication module 107, to a centralized server comprising an accurate up-to-date reference of what each display device 100 is supposed to display.

In one embodiment, verifying whether the display data/information is accurate may comprise connecting to the centralized server 210, downloading the latest location data from the centralized server 210, verify the downloaded data, and perform an update/modification if needed. In one embodiment, after the display device 100 has determined that it (the display device 100) is configured to display the correct data, the display device may be configured to display the product information (407).

In one embodiment, the display device 100 may be configured to prompt and/or otherwise notify a navigation 203 to direct the user to its location. As discussed above, the navigation 203 may utilize any system of navigating the user through a space, including but not limited to, using arrows, sounds, words, and/or the like.

In one embodiment, the navigation device 203 and/or the centralized server 210 may be configured to determine the shortest possible route between one or more display devices 100 and the current location of the navigation device 203. The navigation device 203 may access the layout of the defined space using any method such as connecting to the centralized server 210 and downloading the layout, generating the layout of the defined space based on received location information from a network of display devices 100, and/or any other method configured to associate the layout of the defined space with the navigation device 203. After the navigation device 203 has access to the layout, the navigation device 203 may be receive, as an input, information relating to a specific product and/or display device 100.

For example, in one embodiment in the context of a grocery store, the navigation device 203 may be prompted by a user to locate soft drinks in a store. Each soft drink may be associated with its own display device 100. The navigation device 203 may then request the location information from the display device 100 associated with the soft drink the user wants. Thus, the navigation device 203 is configured with the location of itself relative to the location of the display device 100 associated with the soft drink. The navigation device 203 may be configured to calculate the shortest distance between its (the navigation device 203) location and the location of the display device 100 associated with the particular soft drink the user is looking for, and the navigation device 203 may be configured to direct the user to that location using the methods described above.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. An addressable product information system for a product located in a defined space, the product information system comprising:
a centralized server configured to contain a database of product information;
a display device configured to display product information, wherein the display device comprises:
a housing;
a display panel coupled to the housing and visible from an outside surface of the housing, wherein the display panel is configured to display product information;
a communication module disposed within the housing and communicatively linked to the centralized server, wherein the communication module is configured to:
receive product information from the centralized server; and
transmit a location of the display device within the defined space to the centralized server in real time; and
a control unit configured to:
detect the location of the display device within the defined space;
process the received product information; and
operate the display panel to display the processed product information.

2. The product information system of claim 1, wherein the control unit comprises a processor.

3. The product information system of claim 1, wherein the display device is portable to any location within the defined space.

4. The product information system of claim 1, wherein the control unit is configured to alert the centralized server of the location of the display device upon a change of the location.

5. The product information system of claim 1, wherein the product information comprises at least one of the identity of the product and the price of the product.

6. The product information system of claim 1, wherein the centralized server is further configured to contain a multidimensional map of the defined space and to identify the location of the device display within the multidimensional map.

7. The product information system of claim 1, wherein the display device is electrically coupled to a power source.

8. The product information system of claim 1, wherein the display device is configured to be wirelessly powered.

9. The product information system of claim 8, wherein the display device is configured to be wirelessly powered by photovoltaic cells coupled to the outside of the housing and configured to provide power to the display panel, communication module, and the control unit.

10. The product information system of claim 9, further comprising a power storage medium disposed within the housing and electrically coupled to the photovoltaic cells, wherein the power storage medium is configured to store the electricity produced by the photovoltaic cells.

11. The product information system of claim 1, wherein the display device comprises an internal power source.

12. The product information system of claim 1, wherein the display device further comprises an alert module coupled to the control unit, wherein the alert module comprises a beacon that is at least one of audible and visual.

13. The product information system of claim 1, wherein the display device is assigned a unique address, wherein the centralized server is configured to recognize the unique address and identify the location of the display device within the defined space based on the unique address.

14. The product information system of claim 1, wherein the display device further comprises an infrared occupancy sensor configured to dim the brightness of the display panel in the absence of occupancy and prompt full brightness of the display panel during occupancy.

15. An addressable product information system for locating a product within a defined space and guiding a navigational device, the product information system comprising:
a centralized server configured to contain a database of product information;
a portable display device configured to display the product information, wherein the display device comprises:
a housing;
a display panel coupled to the housing and visible from an outside surface of the housing, wherein the display panel is configured to display product information;
a communication module disposed within the housing and communicatively linked to at least one of the centralized server and the navigational device, wherein the communication module is configured to:
receive product information from the centralized server; and
transmit a location of the display device within the defined space to at least one of the centralized server and the navigational device in real time;
a control unit configured to:
detect the location of the display device within the defined geographical area;
process the received product information; and
operate the display panel to display the processed product information; and
a plurality of photovoltaic cells coupled to the outside of the housing and configured to provide power to the display panel, communication module, and the control unit.

16. The product information system of claim 15, wherein the control unit comprises a processor.

17. The product information system of claim 15, further comprising a power storage medium disposed within the housing and electrically coupled to the plurality of photovoltaic cells, wherein the power storage medium is configured to store the electricity produced by the plurality of photovoltaic cells.

18. The product information system of claim 15, wherein the display device further comprises an alert module coupled to the control unit, wherein the alert module comprises a beacon that is at least one of audible and visual and is activated when the navigation device enters a preselected range from the display device.

19. The product information system of claim 15, wherein the control unit is configured to alert the centralized server of the location of the display device upon a change of the location.

20. The product information system of claim 15, wherein the product information comprises at least one of the identity of the product and the price of the product.

21. The product information system of claim 15, wherein the centralized server further comprises a multidimensional map the defined space and is configured to identify the location of the device display within the multidimensional map.

22. The product information system of claim 21, wherein the communication module is configured to transmit a signal to the navigation device to provide the navigation device a route through the multidimensional map of the defined space to the location of the display device.

23. The product information system of claim 15, wherein the display device is assigned a unique address, wherein the centralized server is configured to recognize the unique address and identify the location of the display device within the defined space based on the unique address.

24. The product information system of claim 15, further comprising a ceiling hub communicatively linked to the control unit and the navigation device, wherein the ceiling hub is configured to relay the location of the display device to the navigation device.

25. The product information system of claim 24, wherein the ceiling hub is configured to be attached to a surface in a fixed position and in communication range of the display device.

26. The product information system of claim 15, wherein the defined space is a defined space.

27. An addressable product information system for locating a product within a defined space and guiding a navigational device, the product information system comprising:
a centralized server configured to contain a database of product information and a multidimensional map of the defined space;
a portable display device configured to display the product information, wherein the display device comprises:
a housing;
a display panel coupled to the housing and visible from an outside surface of the housing, wherein the display panel is configured to display the product information;
a communication module disposed within the housing and communicatively linked to at least one of the centralized server and the navigational device, wherein the communication module is configured to:
receive product information from the centralized server; and
transmit a location of the display device within the defined space to at least one of the centralized server and the navigational device in real time; and
a control unit configured:
to detect the location of the display device within the defined geographical area;
operate the display panel to display the product information; and
guide the navigation device through the multidimensional map of the defined space to the location of the display device;
a plurality of photovoltaic cells coupled to the outside of the housing and configured to provide power to the display panel, communication module, and the control unit; and
a power storage medium disposed within the housing and electrically coupled to the plurality of photovoltaic cells, wherein the power storage module is configured to store the electricity produced by the plurality of photovoltaic cells; and
a ceiling hub communicatively linked to the control unit and the navigation device, wherein the ceiling hub is configured to relay the location of the display device to the navigation device.

28. The product information system of claim 27, wherein the display device further comprises an alert module coupled to the control unit, wherein the alert module comprises a beacon that is at least one of audible and visual and is activated when the navigation device enters a preselected range from the display device.

29. The product information system of claim 27, wherein the control unit is configured to alert the centralized server of the location of the display device upon a change of the location.

30. The product information system of claim 27, wherein the product information comprises at least one of the identity of the product and the price of the product.

31. The product information system of claim 27, wherein the display device is assigned a unique address, wherein the centralized server is configured to recognize the unique address and identify the location of the display device within the defined space based on the unique address.

32. The product information system of claim 27, wherein the ceiling hub is configured to be attached to a surface in a fixed position and in communication range of the display device.
